(19) United States
(12) Patent Application Publication
(10) Pub. No.: US 2003/0174059 A1
(43) Pub. Date: Sep. 18, 2003

(54) Home detention system

(76) Inventor: Michael Reeves, Bourbonnais, IL (US)

Correspondence Address: Sonya C. Harris, PO Box 2607, Fairfax, VA, 22031, US

(21) Appl. No.: 10/094,623

(22) Filed: Mar. 12, 2002

(51) Int. Cl. G08B 23/00

(52) U.S. Cl. 340/573.4; 340/568.2

(57) ABSTRACT

There is provided a small transmitter designed to be worn by a detainee in a house arrest system. A tamper-resistant band retains a housing on an appendage (e.g., a wrist or ankle, etc.) of the detainee. The band contains stainless steel strands for strength. In addition, a fiber optic stand connected at one end of the band to a light source and at the other end to a light detector is used to detect severance of the band. The band may also have a conductive portion in contact with the skin of the detainee. The conductive portion is connected to a proximity detector so that in the event that a detainee managed to remove the device without severing the band and, consequently, the fiber optic strand, an alert could be generated at a monitoring station. Tamper alerts as well as low battery status are transmitted by a low power, RF transmitter within the housing. An IR control port is provided to selectively activate and deactivate the unit. The IR control port may also be used to selectively activate and deactivate individual features or to set other operating modes.

### FIELD OF THE INVENTION:

The present invention relates to devices for monitoring people within a specific area and, more particularly, to a portable transmitter having built-in anti-tamper features which is intended to be worn by a person under house arrest so that the detention of that person within a predetermined area is ensured.

### BACKGROUND OF THE INVENTION

The concept of remote confinement or “house arrest”, as it is sometime known, has gathered a great deal of popularity in recent years. This popularity has, at least in part, been fostered by the overcrowded conditions in prisons and jails in combination with the swelling ranks on non-violent offenders. However, the cost of guarding an individual to enforce a house arrest is, in most cases, prohibitive. What is required is a system that can remotely ensure that a person under house arrest stays confined within the predetermined limits imposed by his or her sentence. These systems should, of course, be relatively foolproof and reliable. Humanitarian concerns dictate that any device to be worn by a detainee should be reasonably comfortable. There should be substantially no way that a detainee may remove or otherwise disable or circumvent any monitoring device. There have been numerous attempts to provide monitoring devices and systems for use in remotely enforcing a house arrest.

### DISCUSSION OF THE PRIOR ART

U.S. Pat. No. 4,747,120 for AUTOMATIC PERSONNEL MONITORING SYSTEMS, issued May 24, 1988, to Steven L. Foley, Jr. teaches one such system. FOLEY teaches a decoder attached to a telephone, the decoder being adapted to receive an encoded object such as a wrist band or the like. The wrist band carries a mechanism for generating a unique code associated with the person being monitored. Upon insertion of the wrist band into the decoder, a signal is generated and sent from the decoder to a central monitoring location. This action verifies to monitoring personnel that the detainee is in the designated location at the time of the call. A timer within the decoder randomly dials the monitoring site and, upon proper completion of the call, the detainee is given a predetermined amount of time to insert the encoded wristband into the decoder. Failure of the detainee to do so triggers an alarm event at the monitoring site. Tamper detection features are built into the wristband so that if the band has been cut or otherwise mutilated, that information is communicated to the monitoring site.

In contradistinction, the apparatus of the present invention features a portable transmitter for either continuously or periodically generating and radiating a radio frequency signal. The transmitter is housed in a small housing designed to be worn by a detainee, typically on an ankle or wrist. A band secures the housing to the detainee's appendage. The band contains both stainless steel strands for strength and a fiber optic strand for reliably monitoring band integrity. In addition, the band may have an electrically conductive surface which, in cooperation with a proximity detection circuit within the housing, can determine whether the transmitter is still in place on the detainee's body. This is important in the event that the detainee is able to somehow slip the housing and band off his or her ankle or wrist. Unlike the apparatus taught by FOLEY, no periodic action, such as placing an encoded device in a receiver, is required. Rather, monitoring is continuous and automatic.

U.S. Pat. No. 4,843,377 for REMOTE CONFINEMENT SYSTEM, issued Jun. 27, 1989, to Kip L. Fuller, et al., teaches another monitoring system. In addition to monitoring a detainee's presence at a given site, the FULLER, et al., system also provides an ability to monitor breath alcohol or, by monitoring other body fluids (e.g., blood, urine, saliva), the presence of other prohibited substances. Detainee identification may be made directly from some inherent characteristic of the detainee. For example, a camera may produce an image from which unique features may be extracted. Voice recognition is another method which may be used. These methods eliminate the need for an encoded device worn by a detainee. An automatic dialer connects the remote confinement site to a central monitoring location. While the telephone system is the method of choice for connecting the detainment site to the monitoring site, the television cable system and over-the-air connections are also disclosed.

The inventive system, on the other hand, provides no provision for monitoring prohibited substances. Neither does the inventive system rely of some unique characteristic of the detainee for identification purposes. Rather, the inventive system features a transmitter in a housing secured to an appendage of a detainee by a high-security strap. The use of both a fiber optic strand and a proximity detection tamper deterrent and detection device improves the reliability of the inventive retention strap over other methods or devices of the prior art.

U.S. Pat. No. 4,924,211 for PERSONNEL MONITORING SYSTEM, issued May 8, 1990, to Ronald C. Davies teaches a system wherein a wrist band contains multiple, parallel, embedded conductive strands. These strands are positioned closely together so that any attempt to sever the strap is readily detected. This is accomplished by placing varying potentials on adjacent conductors and monitoring these individual potentials.

The band of the invention, on the other hand, features a fiber optic strand embedded within the strap. While electrical conductors such as those taught by DAVIES have been used in prior art devices, they are more readily defeated than is a fiber optic strand connected to a light source at a first end and to a light detector at the other end.

U.S. Pat. No. 4,952,913 for TAG FOR USE WITH PERSONNEL MONITORING SYSTEM, issued Aug. 28, 1990, to James D. Pauley, et al., teaches a monitoring anklet having sophisticated tamper detection features. First the PAULEY, et al., anklet carries a conductive element so that severance of the anklet is detected. A pair of conductive pads on the inside surface of the anklet serve as capacitive elements with the detainee's skin providing the dielectric.

The band of the present invention includes an optical fiber strand to replace the electrical conductor taught by PAULEY, et al. The optical fiber band integrity detector is inherently more reliable (i.e., harder to circumvent) than electrical conductors such as those taught by PAULEY, et al.

U.S. Pat. No. 5,103,474 for DRIVE-BY PERSONNEL MONITORING SYSTEM WITH RADIO LINK, issued Apr. 7, 1992, to Veronica Stoodley, et al., teaches a system wherein a detainee wears a transmitter or the like which communicates with a local receiver. The local receiver may be actuated by a RF signal generated, for example, by a monitoring officer in a passing car. Two-way voice communication is provided between the officer and the local receiver. In addition, the detainee may transmit a signal indicating that he or she desires a face-to-face meeting with the officer.

The present invention teaches a band containing a fiber optic strand and a proximity detector to ensure that the band is neither severed nor removed from the detainee. There is no such disclosure in STOODLEY, et al. The inventive system provides no two-way communication between a local receiver near the detainee and a passing monitoring officer.

U.S. Pat. No. 5,170,426 for METHOD AND SYSTEM FOR HOME INCARCERATION, issued Dec. 8, 1992, to Frederick D. D'Alessio, et al., teaches a remote system for monitoring the presence of a detainee. A calibrated voice recognition system is used to verify the authenticity of a person calling a monitoring center over a telephone. Caller ID verifies the location from which the detainee has called the monitoring center.

The home detention system of the present invention uses no voice recognition for verification of the location and/or identity of a detainee. Rather, a secure personal transmitter is monitored to verify the presence of the detainee within a predetermined, monitoring area.

U.S. Pat. No. 5,448,221 for DUAL ALARM APPARATUS FOR MONITORING OF PERSONS UNDER HOUSE ARREST, issued Sep. 5, 1995, to Robert N. Weller teaches a system wherein a detainee wears an apparatus having two-way voice communication capability with a base station.

The inventive system provides no such two-way voice communication between the detainee and either a local receiver or a remote monitoring system.

U.S. Pat. No. 5,831,535 for ELECTRONIC MONITORING DEVICE AND MONITORING SYSTEM INCLUDING SAME, issued Nov. 3, 1998, to Yoav Reisman, et al., teaches an electronic monitoring device to be worn by a detainee and having a closure with a unique identification generation mechanism within.

The inventive band, on the other hand, provides no unique identification generation apparatus within a clasp of a band attached to a detainee. Rather, the inventive band is permanently affixed to the detainee (i.e., there is no clasp on the inventive band). While the inventive transmitter does transmit an ID code, that code is pre-programmed and typically is not changeable.

U.S. Pat. No. 6,054,928 for PRISONER TRACKING AND WARNING SYSTEM AND CORRESPONDING METHODS, issued Apr. 25, 2000, to Jerome H. Lemelson (deceased), et al., teaches a system for learning a detainee's behavior patterns and using an artificial intelligence (AI) apparatus to analyze subsequent detainee behavior.

The inventive band and systems for using the band have no provision for monitoring detainee behavior and then using an AI approach to monitor subsequent behavior.

U.S. Pat. No. 6,101,242 for MONITORING FOR KEY WORDS WITH SIV TO VALIDATE HOME INCARCERATION, issued Aug. 8, 2000, to Alexander I. McAllister, et al., teaches as system wherein voice recognition is used in cooperation with caller ID to positively identify a detainee and ascertain that the detainee is at a specific location.

The inventive home detention system, on the other hand, does not use voice recognition to either identify a detainee or to ascertain that the detainee is at a particular location.

None of these patents either teaches or suggests the wrist/ankle strap of the present invention wherein the strap or band relies upon a fiber optic strand for band integrity detection.

It is therefore an object of the invention to provided a transmitter to be worn by a detainee in a house arrest system.

It is another object of the invention to provide a transmitter to be worn by a detainee in a house arrest system which is retained upon an appendage of the detainee by a high-security, tamper resistant band.

It is also an object of the invention to provide a transmitter to be worn by a detainee in a house arrest system wherein the tamper resistant band contains an optical fiber which, in combination with a light source and light detector, provides highly reliable band severance detection.

It is a further object of the invention to provide a transmitter to be worn by a detainee in a house arrest system also incorporating a proximity detection system to sense if the transmitter has been removed from the detainee's body without severing the strap.

It is an additional object of the invention to provide a transmitter to be worn by a detainee in a house arrest system wherein each individual transmitter may be uniquely identified so that multiple detainees may be remotely monitored.

It is a still further object of the invention to provide a transmitter to be worn by a detainee in a house arrest system wherein the wrist/ankle band contains multiple stainless steel strands for strength.

It is another object of the invention to provide a transmitter to be worn by a detainee in a house arrest system which has a control port through which the transmitter may be activated or deactivated.

It is an additional object of the invention to provide a transmitter to be worn by a detainee in a house arrest system in which the control port is an infrared (IR) control port.

It is an another object of the invention to provide a transmitter to be worn by a detainee in a house arrest system to provide an IR control port through which one or more operating modes or features may be selected and deselected.

### SUMMARY OF THE INVENTION

The present invention features a small transmitter designed to be worn by a detainee in a house arrest system. A tamper-resistant band retains a housing on an appendage (e.g., a wrist or ankle, etc.) of the detainee. The band contains stainless steel strands for strength. In addition a fiber optic stand connected at one end of the band to a light source and at the other end to a light detector is used to detect severance of the band. The band may also have a conductive portion in contact with the skin of the detainee. The conductive portion is connected to a proximity detector so that in the event that a detainee managed to remove the device without severing the band and, consequently, the fiber optic strand, an alert could be generated at a monitoring station. An IR control port allows activation and deactivation of the transmitter. In addition, the IR port may be used to selectively enable or disable features such as the proximity detector.

### BRIEF DESCRIPTION OF THE DRAWINGS

A complete understanding of the present invention may be obtained by reference to the accompanying drawings, when taken in conjunction with the detail description thereof and in which:

FIG. 1a is a cross sectional schematic view of the wrist strap of the invention;

FIG. 1b is a top plan schematic view of the wrist strap of FIG. 1a;

FIG. 2 is a side elevational schematic view of the wrist strap of FIG. 1a;

FIG. 3 is a partially exploded, perspective view of the transmitter housing and wrist strap of the invention;

FIG. 4 is a rear, perspective view showing end plates in place of the housing;

FIG. 5 is schematic view of a detainee, a local receiver and a monitoring station;

FIG. 6 is a schematic block diagram of a local receiver; and

FIG. 7 is a flow chart of the operation of the home detention system of the invention.

### DESCRIPTION OF THE PREFERRED EMBODIMENT

Generally speaking this invention relates to a system for ensuring the presence of a person within a predetermined area. The system has three components: a novel personal transmitter assembly designed to be worn by a person being detained within a given geographic area; a local receiver; and a remote monitoring facility. The transmitter is semi-permanently attached to a detainee by a strap having unique tamper detection elements. It will be recognized that the operational philosophy could be reversed and the inventive transmitter used to warn of the incursion of a previously identified, undesirable person entering a controlled (i.e., monitored) space. A typical example would be a known sexual predator or pedophile could be equipped with a transmitter and a school or other such establishment could be equipped with a monitoring system to detect this person.

A local receiver is provided to receive signals from the detainee-worn personal transmitter. Finally, a link is provided between the local receiver and a central monitoring station.

The term detainee will be used herein to designate the wearer of the inventive personnel monitoring device, regardless of the circumstances requiring the wearing of the monitoring device.

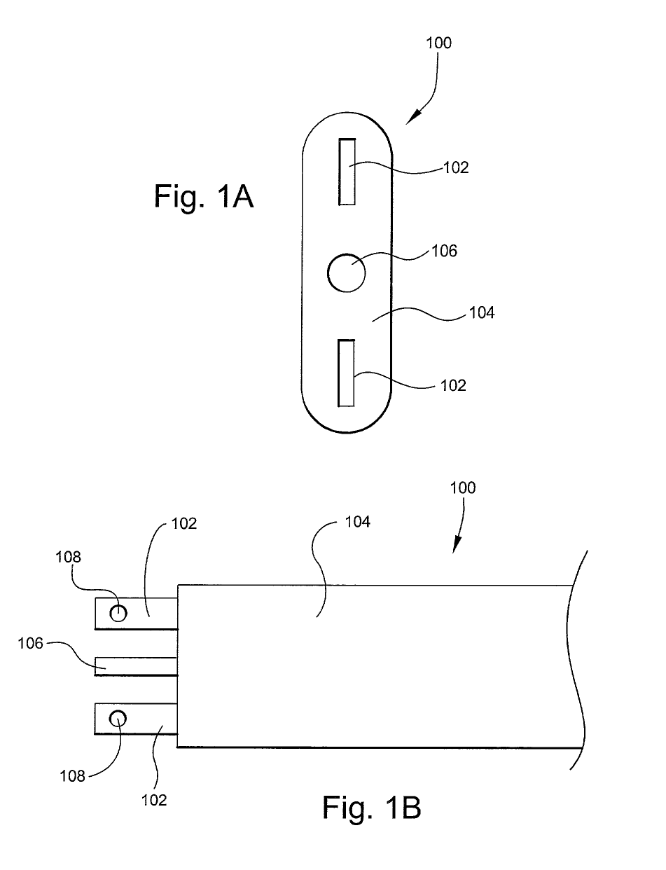

Referring first to FIGS. 1a and 1b, there are shown cross sectional and top plan, schematic views respectively, of a first embodiment of an ankle or wrist band suitable for attaching a small transmitter to a detainee, generally at reference no. 100. In the preferred embodiment, band 100 is preferably placed around the ankle of a detainee. It could, when properly sized, be applied to an arm, leg or wrist. A pair of flat stainless steel strips 102 are embedded in the core 104 of the band 100 for providing strength and for providing an electrical interface to the electrically-conductive core material 104. While in the embodiment chosen for purposes of disclosure, stainless steel strips 102 have a substantially rectangular cross-sectional area, other cross-sectional shapes could also be utilized. Strips 102 extend beyond each end of core 104 and each have holes 108 disposed in both their proximal and distal ends. It will be recognized by those skilled in the art that materials other than stainless steel could also be used and that a different number of strips 102 could be chosen to meet a particular operating requirement.

Core 104 is made from any suitable flexible, electrically conductive material. A carbon-loaded synthetic rubber or similar polymeric material has been found to provide the flexibility, wear resistance, and electrical conductivity required for the application. The core 104 material chosen must also adequately support and protect the band's internal components. It has been found that material have a bulk resistance of approximately 1000 ohms are satisfactory for this application.

At least one fiber optic strand 106 is disposed in core 104, also extending beyond both the ends of core 104. While a single optical fiber 106 has been chosen for purposes of disclosure, it will be recognized that additional optical fibers 106 could also be used.

Band 100 is typically formed by extruding the core material over the fiber optical strand 106 and stainless steel strips 102. Other formation techniques such as molding or machining could be used depending on the material chosen for core 104.

Core 104 is adapted to contact the skin of the detainee and is operatively connected to a proximity detector circuit (not shown). The proximity detector circuit which utilizes the capacitance presented by the detainee's body to ground to ensure that the band 100 is still in place on a detainee's ankle, wrist, or other body part. When contact is lost between a detainee's skin and core material 104, an alarm signal is generated by the proximity detector circuit. The proximity detector circuit may be configured such that it may be selectively enabled and disabled through a control port, typically an IR port (not shown). In alternate embodiments, conductive pads or electrodes (not shown) used with a non-conductive core material (not shown) could replace the electrically conductive core 104.

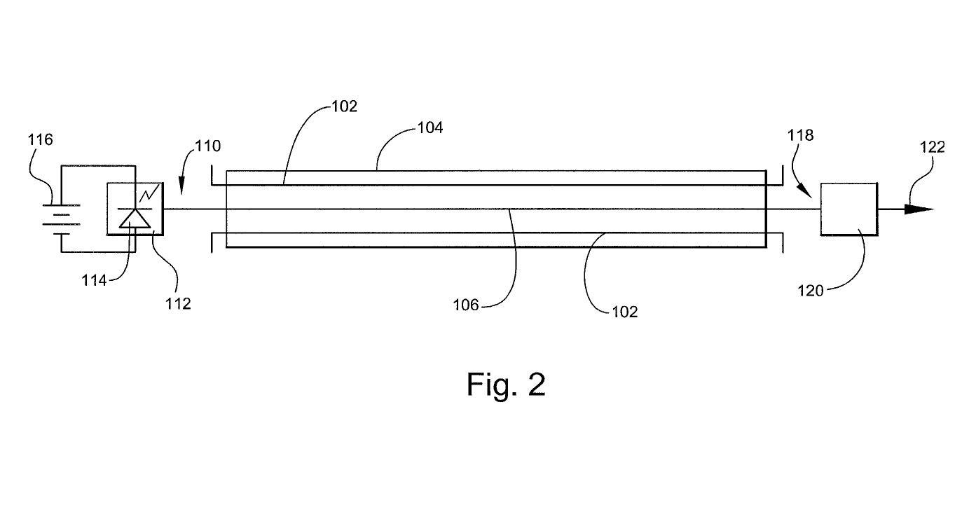

Referring now to FIG. 2, there is shown a schematic, longitudinal view of band 100. Stainless steel strips 102 are disposed in the core material 104 and extend beyond the ends thereof. The extended portions of stainless steel strips 102 allow for electrical connections (not shown) to be made between the electrically conductive core material 104 and a proximity detector circuit (not shown). Fiber optic strand 106 is connected at a first end 110 to a light source 112. Light source 112 is typically a light emitting diode (LED) 114 generating light having a wavelength in the infrared (IR) region. LED 114 is shown directly connected to a battery 116. Battery 116 is representative of any power source suitable for illuminating LED 114. It will also be recognized by those skilled in the art that control circuitry could easily be interposed between battery 116 and LED 114 to only periodically illuminate the other end 118 of fiber optic strand 106. Light detector 120 is typically a photo transistor (not shown) or the like having sensitivity at a wavelength compatible with the output wavelength of LED 114. It will be recognized by those of skill in the art that other types of compatible light source/photo detector devices (not shown) could also be used in this application. An output 122 from light detector 120 is provided to tamper detection circuitry (not shown). In operation, if optical fiber strand 106 is severed, light from light source 112 passing through optical fiber 106 will no longer impinge upon light detector 120 thereby causing an alert signal to be generated at output 122.

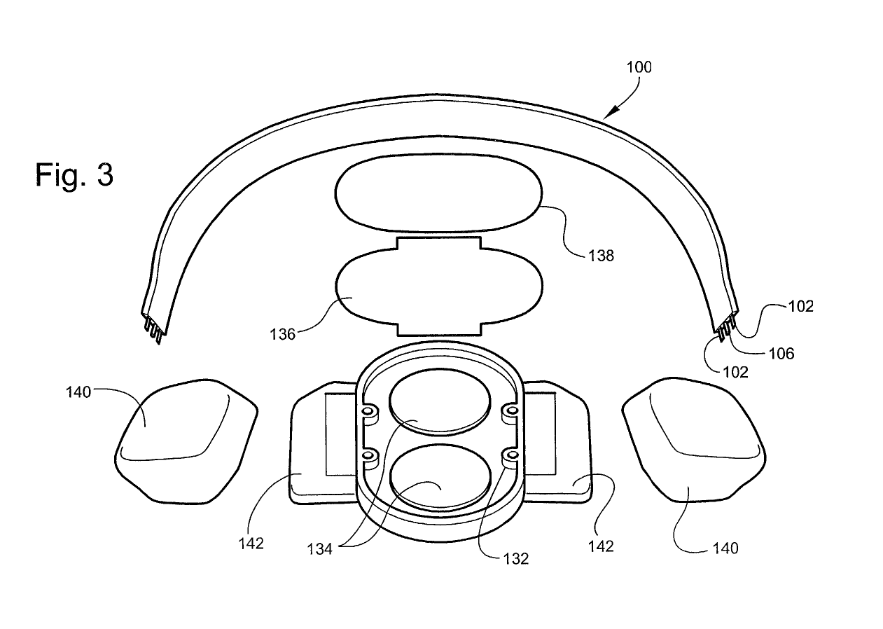

Referring next to FIG. 3, there is shown a perspective, partially exploded schematic view of the transmitter and band 100 of the invention. A housing 132 holds a pair of flat batteries 134. While two batteries have been chosen for purposes of disclosure, it will be recognized that other battery types, counts, or arrangements could be chosen for alternate embodiments of the inventive transmitter. A printed circuit board 136 containing electronic components on one or both sides is adapted to fit into housing 132 above batteries 134. A cover 138 securely closes housing 132 by means of tamper-resistant screws (not shown). In the embodiment chosen for purposes of disclosure, eight tamper resistant screw have been used. Other screw counts or other fastener types could also be used to attach cover 138 to housing 132 in a secure, tamper-resistant manner. End plates 140 are designed to slide over the side regions 142 of housing 132. This prevents access to the heads of the tamper-resistant screws (not shown). End plates 140 are permanently latched into their respective positions and may only be removed destructively.

Each end of band 100 is mechanically attached to housing 132 and electrically and optically attached to appropriate connection points on printed circuit board 136.

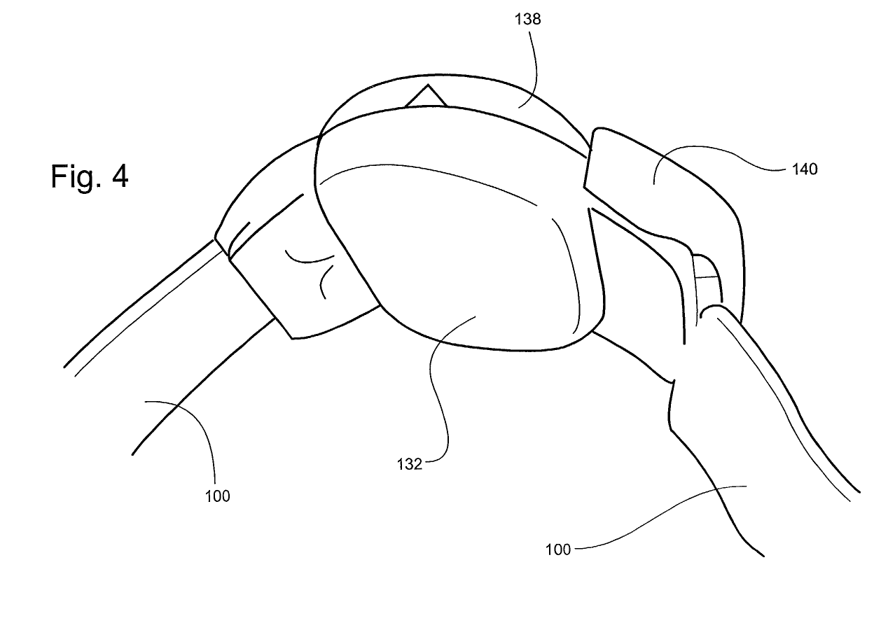

Referring now also to FIG. 4, there is shown a perspective view of band 100 assembled with housing 132 and with end plates 140 in place.

A transmitter circuit is provided on printed circuit board 136. The transmitter operates at a carrier frequency in the range of approximately 300 MHz and utilizes a pulsed amplitude modulation (AM) modality for digitally encoding status information regarding the band 100, its status regarding severance of its fiber optic strand 106, its proximity of the detainee and its battery condition. In addition three bits are used as a transmitter ID. In the embodiment chosen for purposes of disclosure, these three ID bits are preprogrammed. In alternate embodiments, however, the ID bits could be made programmable through the IR control port (not shown). Transmission times are programmable and typically occur at between 20 second and two minute intervals. A transmission sequence consists of sending 7 or 8 bits (i.e., bursts) of approximately 500-600 μS duration with the sequence repeated approximately seven times. It will be recognized by those skilled in the data communications arts that other frequencies, data encoding schemes and/or transmission modalities could be chosen in lieu of the one chosen for purposes of disclosure, and the inventive transmitter is not considered limited to the parameters chosen for purposes of disclosure.

Three events are monitored by the inventive personal transmitter: band integrity, unit in place on detainee (proximity) and low battery condition. Other parameters could, of course also be monitored by appropriately modifying the transmitted bit structure.

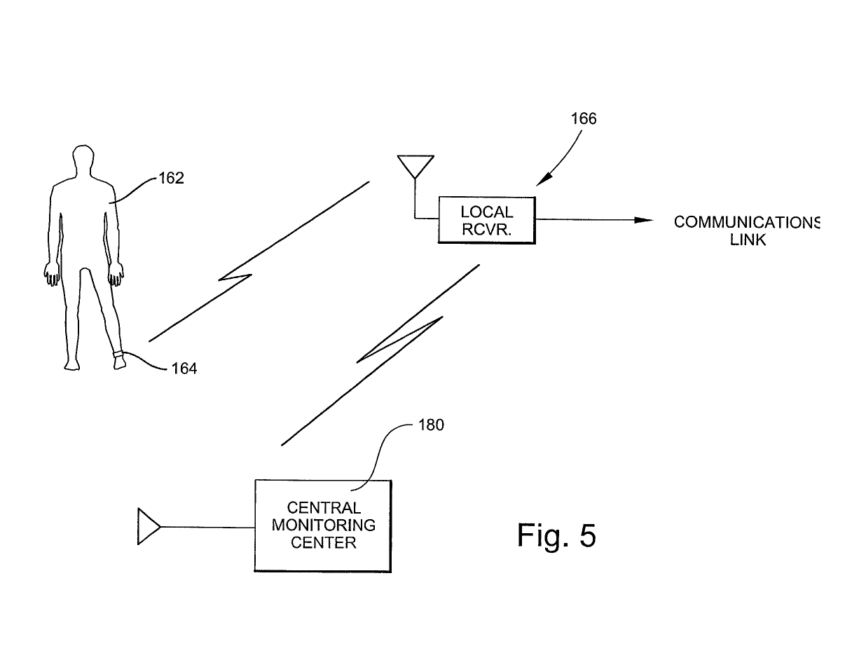

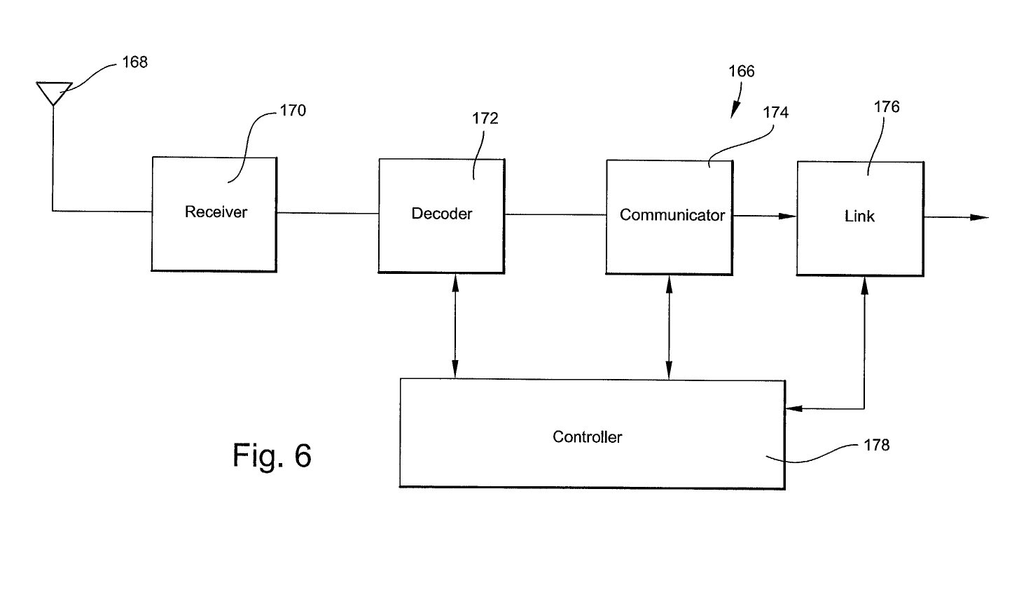

Referring now to FIG. 5 there is shown a simplified system block diagram. A detainee 162 is shown with the inventive personal transmitter 154 installed on an ankle. An RF communications link is shown between personal transmitter 164 and a local receiver 166. Referring now also to FIG. 6, there is shown a more detailed schematic block diagram of local receiver 166. Local receiver 166 has an antenna 168 tuned to the operating frequency of the personal transmitter, typically approximately 300 MHz. Antenna 168 is attached to a receiver portion 170 which receives RF signals from antenna 168 and both amplifies and detects those signals. Receiver portion 170 is connected to decoder 172 which receives an output signal from receiver portion 170 and extracts the digitized information transmitted by personal transmitter 164. Decoder 172 is connected at its output to a communications unit 174 which is, in turn, selectively and periodically connected to a communications link 176. It will be recognized by those of skill in the art that communications link 176 may be implemented in a variety of ways. These include common-carrier dial up lines, leased private circuits, cellular phone connections, satellite links, radio frequency (RF) links (e.g., two-way radio), internet connection, television cable-based link, and any other similar communications link. It will also be recognized that, in alternate embodiments, the individual transmitters 164 (FIG. 5) could be adapted for direct (i.e., without an intermediate local receiver 166) monitoring by monitoring center 180, possibly, in still other alternate embodiments, through a relay and/or concentrator (not shown). A controller 178 connected to decoder 172, communications unit 174 and link 176 supervises the decoding and transmission of data to a central monitoring site 180 (FIG. 5). It should be noted that antenna 168 is configured to define the perimeter of a space within which a detainee is required to remain. Antenna 168 could be a loop antenna completely enclosing the area or could have other directional characteristics to define the monitored area.

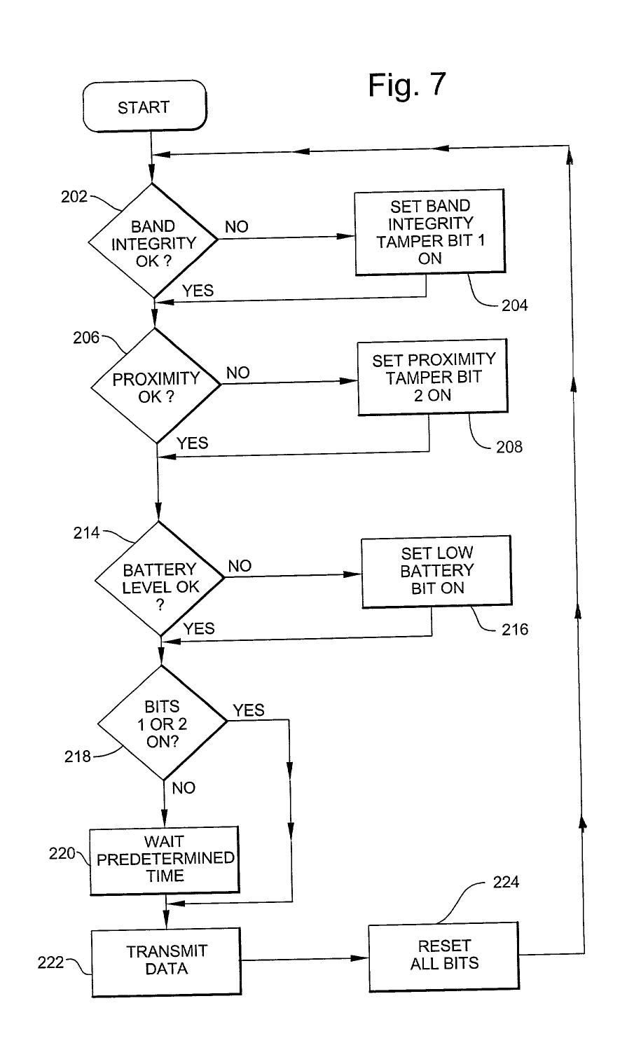

In operation, personal transmitter 164 periodically transmits data to local receiver 166. The data transmitted by personal transmitter 164 is dependent on at least three conditions in personal transmitter 164. Referring now to FIG. 7, there is shown a flow chart of the operation of personal transmitter 164.

Band integrity is first verified, step 202. If the band 100 (FIG. 1) has been severed or mutilated in some manner such that the light path from light source 112 (FIG. 1) through fiber optic strand 106 (FIG. 1) to light detector 120 (FIG. 1) has been broken, a band integrity bit 1 is set active, step 204.

A proper proximity signal is next verified, step 206. If the band 100 is no longer properly in place on the ankle, wrist, etc. of a detainee, the proximity tamper bit 2 is set active, step 208.

The battery condition (i.e., degree of charge) is checked, step 214. If the amount of energy remaining in the battery is below a predetermined threshold, the low-battery bit is set active, step 216.

Tamper bits 1 or 2 are checked, step 218. If neither bit 1 or 2 is set active, transmission is delayed until the next predetermined transmission time arrives, step 220. At the next predetermined transmission time, the data us transmitted, step 222. If, however, either of the tamper bits 1 or 2 are active, step 220, then the data is immediately transmitted, step 222. A three-bit ID code of the transmitter is transmitted with the tamper detect and low battery bits.

After the data has been transmitted, step 222, all the bits are reset to an inactive (i.e., off) state 224 and control is transferred to step 202 and the monitoring process is repeated until the band 100 is removed from the detainee.

It will be recognized that the “bit” model chosen to illustrate the operation of the personal transmitter could be replaced by many other data capture and transmission methods well known to those skilled in the data communications art. It will also be recognized that the steps could be performed in alternate sequences from that chosen for purposes of disclosure.

Since other modifications and changes varied to fit a particular operating requirements and environment will be apparent to those skilled in the art, the invention is not considered limited to the example chosen for purposes of disclosure, and covers all changes and modifications which do not constitute a departure from the true spirit and scope of the invention.

Having thus described the invention, what is desired to be protected by Letters Patent is presented in the subsequent appended claims.

What is claimed is:

1. An apparatus to be worn by a detainee under house arrest, comprising:
a) a housing;
b) a light source disposed in said housing, said light source having an output for providing a light signal;
c) a light detector disposed in said housing and having an input for receiving a light signal and producing an electrical signal representative thereof;
d) a band having a first end and a second end, said first and said second ends each being securely but removably attached to said housing, said band comprising at least one fiber optic strand disposed within said band between said first and said second ends thereof, a first end of said at least one fiber optic strand being operatively connected to said output of said light source and a second end of said at least one fiber optic strand being operatively connected to said input of said light detector such that a light conducting path for carrying said light signal is established therebetween;
e) means for monitoring continuity of said light signal through said optical path and for generating an alert signal upon interruption of said light at said light detector;
whereby severance of said band is detected.

2. The apparatus to be worn by a detainee under house arrest, as recited in claim 1, further comprising:
e) a radio frequency (RF) transmitter disposed in said housing and operatively connected to said monitoring means and adapted to transmit at least said alert signal.

3. The apparatus to be worn by a detainee under house arrest, as recited in claim 2, wherein said band is adapted to be securely attached to a detainee's body proximate to and encircling a body member from the group: ankle, leg, wrist, and arm.

4. The apparatus to be worn by a detainee under house arrest, as recited in claim 3, said band is provided in a plurality of different, predetermined lengths to facilitate said secure attachment to said body member of said detainee.

5. The apparatus to be worn by a detainee under house arrest, as recited in claim 4, wherein only one of said first end and said second end of said band is removable from said housing.

6. The apparatus to be worn by a detainee under house arrest, as recited in claim 4, wherein said means for monitoring comprises a data input port adapted to receive at least one of an activation command signal and a deactivation command signal.

7. The apparatus to be worn by a detainee under house arrest, as recited in claim 6, wherein said data input port comprises an infrared (IR) communications port.

8. The apparatus to be worn by a detainee under house arrest, as recited in claim 3, said band comprising an electrically conductive portion adapted to contact said body member of said detainee.

9. The apparatus to be worn by a detainee under house arrest, as recited in claim 8, wherein said electrically conductive portion of said band is adapted to generate a signal representative of the said contact with said body member and wherein said monitoring means further comprises means for monitoring said signal representative of said contact.

10. The apparatus to be worn by a detainee under house arrest, as recited in claim 2, wherein said housing comprises a battery and said monitoring means further comprises means for monitoring a condition of said battery.

11. The apparatus to be worn by a detainee under house arrest, as recited in claim 2, wherein said light source comprises an LED and said light detector comprises a photo transistor.

12. The apparatus to be worn by a detainee under house arrest, as recited in claim 2, wherein said RF transmitter has an operating frequency of approximately 300 MHz and said at least said alert signal is transmitted as a predetermined pattern of pulses.

13. The apparatus to be worn by a detainee under house arrest, as recited in claim 12, wherein said predetermined pattern of pulses is re-transmitted a predetermined number of times.

14. The apparatus to be worn by a detainee under house arrest, as recited in claim 2, wherein said means for monitoring further comprises timing means for delaying generation of said alert signal for a predetermined period of time.

15. A system for ensuring that a detainee remains within a predetermined area, comprising:
a) a personal transmitter securely affixed to the body of a detainee by a tamper resistant band having a fiber optic severance detection means to ensure that the band remains integral, said personal transmitter adapted to transmit a RF signal comprising predetermined information at a predetermined first radio frequency;
b) a local receiver adapted to receive said predetermined information at said first radio frequency, said local receiver being equipped with means for communicating with a remote monitoring center; and
c) a remote monitoring center in periodic communication with said local receiver for monitoring the detention of said detainee.

16. The system for ensuring that a detainee remains within a predetermined area, as recited in claim 15, wherein said local receiver comprises antenna means for receiving said RF signal, said antenna means having at least a directional characteristic which defines a reception area within which said RF signal from said personal transmitter is received.

17. The system for ensuring that a detainee remains within a predetermined area, as recited in claim 16, wherein said personal transmitter further comprises proximity detection means for ensuring said personal transmitter is proximate said detainee.

18. The system for ensuring that a detainee remains within a predetermined area, as recited in claim 17, wherein said predetermined information comprises at least one of the group: low battery, fiber optic strand severed, proximity sensor tamper detected, other tamper detected.

19. The system for ensuring that a detainee remains within a predetermined area, as recited in claim 18, wherein said means for communicating between said local receiver and said remote monitoring center comprises at least one of the group: common carrier dial-up telephone circuit, leased private circuit, cell phone link, satellite link, two-way radio line, internet connection and television cable system.

20. The system for ensuring that a detainee remains within a predetermined area, as recited in claim 19, wherein said transmission of predetermined information from said transmitter comprises a periodic transmission.

21. The system for ensuring that a detainee remains within a predetermined area, as recited in claim 20, wherein said periodic transmission occur at a regular, programmable interval.

22. The system for ensuring that a detainee remains within a predetermined area, as recited in claim 21, wherein said programmable interval is selected to be within the range of approximately 20 seconds to two minutes.

23. A system for sensing the intrusion of a known, unwelcome person into a predetermined area, comprising:
a) a personal transmitter securely affixed to the body of a known and unwelcome person by a tamper resistant band having both fiber optic severance detection and proximity detection means to ensure that the band remains integral and affixed to said person, said personal transmitter adapted to transmit predetermined information at a predetermined first radio frequency;
b) at least one receiver proximate a predetermined area from which said person is to be excluded, said receiver being adapted to receive said predetermined information on said first radio frequency; and
c) monitoring means operatively connected to said receiver for providing an alert when said unwelcome person approaches and enters said predetermined area;
whereby, when said unwelcome person approaches and enters said predetermined area, said at least one receiver generates an alarm.

24. The system for sensing the intrusion of a known, unwelcome person into a predetermined area, as recited in claim 23, wherein said predetermined information comprises at least one of the group: low battery, fiber optic strand severed, proximity sensor tamper detected, other tamper detected.

25. The system for ensuring that a detainee remains within a predetermined area, as recited in claim 24, wherein said transmission of predetermined information from said transmitter comprises a periodic transmission.

26. The system for ensuring that a detainee remains within a predetermined area, as recited in claim 25, wherein said periodic transmission occurs at a regular, programmable interval.

27. The system for ensuring that a detainee remains within a predetermined area, as recited in claim 26, wherein said programmable interval is selected to be within the range of approximately 20 seconds to two minutes

28. The system for sensing the intrusion of a known, unwelcome person into a predetermined area, as recited in claim 27, wherein said at least one receiver comprises a plurality of receivers selectively disposed proximate the perimeter of said predetermined area and defining a detection area substantially coincident with said perimeter.
